(19) United States
(12) Patent Application Publication
(10) Pub. No.: US 2026/0087914 A1
(43) Pub. Date: Mar. 26, 2026

(54) Solar Vocal Alarm Device

(71) Applicant: Malvester Dixon, Martinsville, VA (US)

(72) Inventor: Malvester Dixon, Martinsville, VA (US)

(21) Appl. No.: 19/089,074

(22) Filed: Mar. 25, 2025

Related U.S. Application Data
(60) Provisional application No. 63/698,073, filed on Sep. 24, 2024.

(51) Int. Cl. G08B 7/06; G08B 13/189

(52) U.S. Cl. CPC G08B 7/06; G08B 13/189

(57) ABSTRACT

A motion detection alarm application device is disclosed, which is a motion sensor security camera and alarm system that helps protect property. The system is comprised of a motion detecting sensor, a light, a speaker, a camera, and a controlling application on a smartphone. The sensor portion is powered by a solar panel that absorbs sunlight and converts it to usable power. The device can be placed anywhere the user wishes to protect their property via the security camera and audible alerts. The device will allow the user to use and create a bank of human voice recordings to be used as an alarm. When activated, the sensor will emit the human voice alarm, flash a light, and allow the user to view the intrusion with the camera, all from the user's phone.

### CROSS-REFERENCE TO RELATED APPLICATION

The present application claims priority to, and the benefit of, U.S. Provisional Application No. 63/698,073, which was filed on Sep. 24, 2024, and is incorporated herein by reference in its entirety.

### FIELD OF THE INVENTION

The present invention relates generally to the field of motion detection alarm application devices. More specifically, the present invention relates to a motion detection security camera and alarm system for homes, gardens, and other outdoor property areas. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in motion detection alarm application devices. Generally, people who want to protect their property may opt to use security cameras, motion sensors, and other similar products to do so. Further, intruders may not always be spotted immediately with a standard camera. Furthermore, deer, rabbits, and other animals may ruin a garden if they are not scared away quickly.

Further, if a user is not home, conventional security cameras and motion sensors may not alert a user to an intruder, whether a person or an animal. These conventional security systems may not have the ability to send notifications directly to a homeowner's smartphone. Users may wish to be informed of all intruders to their property, even when they are away. Thus, users may wish to have an alarm and motion sensor which can alert a user's smartphone, such that they can be alerted of intruders even when they are not home.

Accordingly, there is a demand for an improved motion detection alarm application device that provides users with a motion detection security camera and alarm system for homes and other areas. More particularly, there is a demand for a motion detection alarm application device that pairs with a smartphone via Wi-Fi or Bluetooth, sending users a live feed.

Therefore, there exists a long felt need in the art for a motion detection alarm application device that provides users with a motion detection security camera and alarm system for homes, gardens, and other outdoor property areas. There is also a long felt need in the art for a motion detection alarm application device that pairs with a smartphone via Wi-Fi or Bluetooth, immediately notifying homeowners of an intruder and providing them with a livestream video feed. Further, there is a long felt need in the art for a motion detection alarm application device that features a speaker that can announce words and phrases to further deter people from intruding on a person's property. Moreover, there is a long felt need in the art for a device that offers a simple and convenient tool and method of protecting a homeowner's property. Further, there is a long felt need in the art for a motion detection alarm application device that comprises a motion detecting sensor, a light, a speaker, a camera, and a controlling application on a smartphone. Finally, there is a long felt need in the art for a motion detection alarm application device that utilizes a bank of human voice recordings as an alarm.

The subject matter disclosed and claimed herein, in one embodiment thereof, comprises a motion detection alarm application device. The device is a motion sensor security camera and alarm system that helps protect property. The system is comprised of a motion detecting sensor, a light, a speaker, a camera, and a controlling application on a smartphone. The sensor portion is powered by a solar panel that absorbs sunlight and converts it to usable power. The device can be placed anywhere the user wishes to protect their property via the security camera and audible alerts. The device will allow the user to use and create a bank of human voice recordings to be used as an alarm. When activated, the sensor will emit the human voice alarm, flash a light, and allow the user to view the intrusion with the camera, all from the user's phone.

In this manner, the motion detection alarm application device of the present invention accomplishes all of the forgoing objectives and provides users with a device that provides a motion detection security camera which pairs to a smartphone. The device includes a speaker for audible announcements. The device can also flash a light or sound the alarm.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motion detection alarm application device. The device is a motion sensor security camera and alarm system that helps protect property. The system is comprised of a motion detecting sensor, a light, a speaker, a camera, and a controlling application on a smartphone. The sensor portion is powered by a solar panel that absorbs sunlight and converts it to usable power. The device can be placed anywhere the user wishes to protect their property via the security camera and audible alerts. When activated, the sensor will emit the human voice alarm, flash a light, and allow the user to view the intrusion with the camera, all from the user's phone.

In one embodiment, the motion detection alarm application device comprises at least one motion detecting sensor, at least one light, at least one speaker, at least one security camera, and a controlling application on a smartphone. In one embodiment, the motion detecting sensor, light, speaker, and security camera can all be housed together within one structure and mounted around a user's house, front yard, and backyard, etc. In another embodiment, the motion detecting sensor, light, speaker, and security camera are all separate structures and mounted around a user's house and yard.

In one embodiment, each motion detector is mounted to the house, gardens, apartment or other premises or structure being monitored, hereinafter referred to as a house for simplicity sake, or on a structure around the house which could be dedicated to the mounting of the motion detector. For example, a motion detector could be mounted to the exterior wall of the house, to a post around the house, to a tree around the house, or to the roof of the house, etc. The premises or structure being monitored may be any type of premises or structure which is typically monitored for security purposes, including but not limited to, a warehouse, a boatyard, a business, a boat, or a land vehicle such as one with a locating system, etc.

Each motion detector is mounted such that its field of view, i.e., the field in which it detects motion, is around the house in which an intruder could approach the house. For example, a motion detector could be arranged to have a field of view in a path leading to the house, a field of view encompassing a length of a fence around the house or a field or a field of view adjacent the house, i.e., adjacent one or more windows of the house, etc.

Each field of view for a motion detector typically extends over an approximate 180 degree range a sufficient distance from the house, the exact distance depending on the type and construction of the motion detector installed in the alarm device. Of course, the number, placement and coverage area of the motion detectors will usually vary depending on such factors as the plan outline of the house, the location of doors and windows and the surrounding area.

In one embodiment, motion detectors can be standard, off-the-shelf components which provide a signal indicative of the presence of motion above a threshold. In this case, small objects which might be blown aloft by wind, such as leaves, would not trigger the motion detector to provide an output signal. Further, the particular motion detectors selected could be those which only detect animate objects, i.e., humans or animals. In this case, if a fence post in a field of view of a motion detector is being tilted by the wind, it would also not cause the motion detector to provide an output signal. Further, the motion detectors are typically powered by a solar panel or other suitable powering means. The motion detectors are electrically connected to the solar panel. The solar panel absorbs sunlight and converts it to usable power for the motion detectors. Specifically, the solar panels are capable of receiving energy from the sun. The solar panels are placed such that they face toward the sun. Hence, this facilitates the solar panel to encapsulate sufficient and if possible, an optimal amount of solar energy for the motion detector. The solar panels should be kept free of any items that may reduce the available sunlight rays from reaching the solar panels.

In one embodiment, each camera is mounted to the house or on a structure around the house which could be dedicated to the mounting of the camera. For example, a camera could be mounted to the exterior wall of the house, to a post around the house, to a tree around the house, or to the roof of the house, etc.

The mounting location of each camera is selected in dependence on its field of view and the field of view of the motion detector or motion detectors with which it is associated. That is, in a preferred embodiment, each camera is triggered to obtain an image only when its associated motion detector detects motion in the field of view of the motion detector. Since it is this motion (or the cause thereof) for which an image is sought, one or more of the cameras must be positioned to be able to obtain an image of the portion of the field of view of the motion detector in which motion is detected thereby. In some situations, a single camera can be associated with each motion detector and have substantially overlapping fields of view so that when the motion detector detects motion in its field of the view, the camera is triggered to obtain an image which will necessarily encompass the source or cause of that motion. In other situations, two or more cameras can be associated with each motion detector and be spaced apart from one another. Each camera would have a substantially overlapping field of view with the motion detector so that when the motion detector detects motion in its field of the view, both cameras are triggered to obtain images which will necessarily encompass the source or cause of that motion. The use of multiple cameras for each motion detector will aid in the subsequent image processing routine.

In one embodiment, it is also possible that a single camera has a field of view which encompasses the field of view of multiple motion detectors. In this case, when any of a plurality of motion detectors detects motion, that camera will be triggered to obtain an image.

In one embodiment, cameras can also be provided to visualize the house, or parts thereof, i.e., a camera can be mounted on a post distant from the door and directed toward the door to obtain an image of the house including the door. The same would also be applicable for images of the windows.

Of course, the number, placement and coverage area of the cameras will usually vary depending on such factors as the location of the motion detectors, the plan outline of the house, the location of doors and windows and the surrounding area.

In one embodiment, cameras can be standard, off-the-shelf components which obtain images in individual frames and as in some conventional cameras, can be equipped with a light which is triggered when the ambient light is less than a threshold. Cameras can also be used which are infrared cameras which obtain infrared images.

In one embodiment, the security cameras are coupled to the motion detectors, such that the security cameras do not continually operate and obtain images of the environment around or including the house. Rather, the security cameras are only activated to obtain images when motion is detected by the associated one(s) of the motion detectors. This conserves electricity or battery power and is thus especially useful when the security cameras are operating on battery power.

In one embodiment, at least one light is mounted to the house or on a structure around the house which could be dedicated to the mounting of the light. For example, a light could be mounted to the exterior wall of the house, to a post around the house, to a tree around the house, or to the roof of the house, etc. Of course, the number, placement and coverage area of the lights will usually vary depending on such factors as the location of the motion detectors and cameras, the plan outline of the house, the location of doors and windows and the surrounding area.

In one embodiment, lights can be standard, off-the-shelf components with any suitable light bulb as is known in the art. Further, the light can be manually activated, on a timer, triggered when the ambient light is less than a threshold, or activated by a motion sensor or camera. Thus, in one embodiment, the lights flash when an intruder is detected by the motion sensor or camera.

In one embodiment, at least one speaker is mounted to the house or on a structure around the house which could be dedicated to the mounting of the speaker. For example, a speaker could be mounted to the exterior wall of the house, to a post around the house, to a tree around the house, or to the roof of the house, etc. Of course, the number, placement and coverage area of the speakers will usually vary depending on such factors as the location of the motion detectors and cameras, the plan outline of the house, the location of doors and windows and the surrounding area.

In one embodiment, speakers can be standard, off-the-shelf components as is known in the art. Further, the speakers are typically activated by a motion sensor and/or camera to emit a human voice alarm or expel a sound when an intruder is detected. Specifically, the speaker can announce words and phrases to further deter people from intruding on a person's property. Furthermore, a user can create a bank of human voice recordings to be used as an alarm. Thus, when the motion sensor and/or camera is activated, the speaker will emit a human voice alarm.

In one embodiment, the motion detection alarm application device pairs with a user's smartphone via Wi-Fi or Bluetooth, immediately notifying homeowners of an intruder and providing them with a livestream video feed. Specifically, the motion detection alarm application device comprises a software application which is utilized by a user to control the device. Thus, the device is designed to be controlled by and/or provide data to a handheld telecommunications unit, such as a smartphone through the software application. Users can use the software application to view a livestream video feed of the security cameras, send notifications, and/or receive alerts, etc.

In one embodiment, the utility monitoring application device utilizes a smartphone, a tablet, a laptop or a desktop computer, etc., or any other suitable electronic device that has the required operating and memory parameters to support the software application of the present invention.

In one embodiment, the motion detection alarm application device utilizes a mobile computing device (i.e., smart phone, computer, tablet, etc.) comprising a software application which is an alarm app designed to monitor and alert a user to possible intruders detected by the security camera and motion sensor. The mobile or software application provides a secure website and/or smart phone app access by users for monitoring and sending any necessary alerts. In addition to these elements, the device of the present invention may also include: a web server and Cloud database of previous images detected by the security camera and data connectable to the mobile smartphone or portable tablet or computer device.

In one embodiment of the invention, the user's data and data management software are maintained on a Microsoft Cloud server in a typical fashion, or other cloud server, such as the Adobe, Apple or Amazon cloud server, etc. A secure cloud server is used for the protection and security of the user's data, and other needed information data stored on the cloud server for the other services. Thus, the user's data is sent to the cloud server and collected. Conveniently, the data is stored and managed with a data management software or program to manage the collected data.

Typically, a cellular wireless data network embedded in the computer, tablet or smartphone, etc., transmits data and sends alerts, as needed. Such data and alerts can be processed by a Cloud data management server.

In one embodiment, when the motion detection alarm application device is activated (i.e., via the motion detecting sensor and/or camera detecting an intruder), the speaker will emit a human voice alarm, a light will flash, and a notification is sent to a user so that a user can view the intrusion via a live feed with the camera, all from the user's smartphone via the software application.

In yet another embodiment, the motion detection alarm application device comprises a plurality of indicia.

In yet another embodiment, a method of protecting a user's property via a software application paired with a security camera is disclosed. The method includes the steps of providing a motion detection alarm application device comprising a motion detecting sensor, a light, a speaker, a camera, and a controlling application on a smartphone. The method also comprises powering the motion detecting sensor via a solar panel. Further, the method comprises positioning the motion detecting sensor and camera on a user's property. The method also comprises activating the alarm device via an intrusion on the user's property. Finally, the method comprises emitting a human voice alarm, flashing a light, and allowing a user to view the intrusion with the camera, all from a user's smartphone.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the motion detection alarm application device of the present invention showing the security camera powered by a solar panel in accordance with the disclosed architecture;

FIG. 2 illustrates a perspective view of one embodiment of the motion detection alarm application device of the present invention showing the security camera installed on a house in accordance with the disclosed architecture;

FIG. 3 illustrates a perspective view of one embodiment of the motion detection alarm application device of the present invention showing the solar panel powering the device in accordance with the disclosed architecture;

FIG. 4 illustrates a perspective view of one embodiment of the motion detection alarm application device of the present invention showing the device in use during nighttime hours in accordance with the disclosed architecture;

FIG. 5 illustrates a perspective view of one embodiment of the motion detection alarm application device of the present invention showing how the security camera identifies a person, sounds an alert, and sends a notification to a smartphone app in accordance with the disclosed architecture;

FIG. 6 illustrates a flowchart showing the method of protecting a user's property via a software application paired with a security camera in accordance with the disclosed architecture;

FIG. 7 is a schematic diagram illustrating one embodiment of the motion detection alarm application device of the present invention in accordance with the disclosed architecture; and

FIG. 8 illustrates an exemplary user device that is used for installing the motion detection alarm application device of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a motion detection alarm application device that provides users with a motion detection security camera and alarm system for homes, gardens, and other outdoor property areas. There is also a long felt need in the art for a motion detection alarm application device that pairs with a smartphone via Wi-Fi or Bluetooth, immediately notifying homeowners of an intruder and providing them with a livestream video feed. Further, there is a long felt need in the art for a motion detection alarm application device that features a speaker that can announce words and phrases to further deter people from intruding on a person's property. Moreover, there is a long felt need in the art for a device that offers a simple and convenient tool and method of protecting a homeowner's property. Further, there is a long felt need in the art for a motion detection alarm application device that comprises a motion detecting sensor, a light, a speaker, a camera, and a controlling application on a smartphone. Finally, there is a long felt need in the art for a motion detection alarm application device that utilizes a bank of human voice recordings as an alarm.

The present invention, in one exemplary embodiment, is a novel motion detection alarm application device. The device is a motion sensor security camera and alarm system that helps protect property. The system is comprised of a motion detecting sensor, a light, a speaker, a camera, and a controlling application on a smartphone. The sensor portion is powered by a solar panel that absorbs sunlight and converts it to usable power. The device can be placed anywhere the user wishes to protect their property via the security camera and audible alerts. The device will allow the user to use and create a bank of human voice recordings to be used as an alarm. When activated, the sensor will emit the human voice alarm, flash a light, and allow the user to view the intrusion with the camera, all from the user's phone. The present invention also includes a novel method of protecting a user's property via a software application paired with a security camera. The method includes the steps of providing a motion detection alarm application device comprising a motion detecting sensor, a light, a speaker, a camera, and a controlling application on a smartphone. The method also comprises powering the motion detecting sensor via a solar panel. Further, the method comprises positioning the motion detecting sensor and camera on a user's property. The method also comprises activating the alarm device via an intrusion on the user's property. Finally, the method comprises emitting a human voice alarm, flashing a light, and allowing a user to view the intrusion with the camera, all from a user's smartphone.

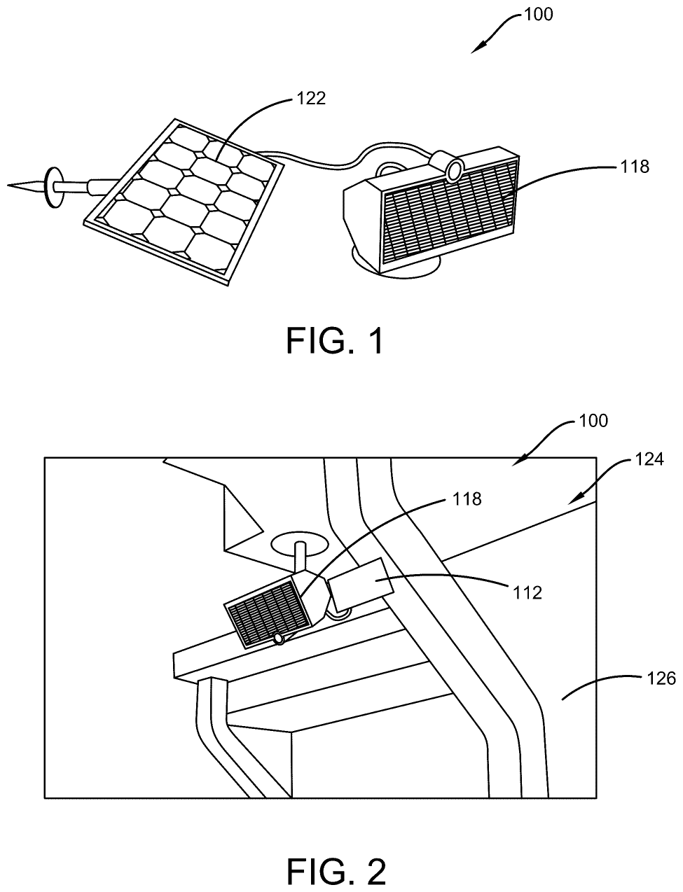

Referring initially to the drawings, FIG. 1 illustrates a perspective view of one embodiment of the motion detection alarm application device 100 of the present invention. In the present embodiment, the motion detection alarm application device 100 is an improved motion detection alarm application device 100 that provides a motion sensor security camera and alarm system that helps protect property. Specifically, the motion detection alarm application device 100 comprises a motion detecting sensor 112, a light 114, a speaker 116, a security camera 118, and a controlling software/mobile application 120 on a smartphone 102. The sensor portion 112 is powered by a solar panel 122 that absorbs sunlight and converts it to usable power. The device 100 can be placed anywhere the user wishes to protect their property via the security camera 118 and audible alerts. When activated, the sensor 112 will emit the human voice alarm, flash a light, and allow the user to view the intrusion with the camera 118, all from the user's phone 102.

Generally, the motion detection alarm application device 100 comprises at least one motion detecting sensor 112, at least one light 114, at least one speaker 116, at least one security camera 118, and a controlling application 120 on a smartphone 102. In one embodiment, the motion detecting sensor 112, light 114, speaker 116, and security camera 118 can all be housed together within one structure and mounted around a user's house 124, front yard, and backyard, etc. In another embodiment, the motion detecting sensor 112, light 114, speaker 116, and security camera 118 are all separate structures and mounted around a user's house 124 and yard.

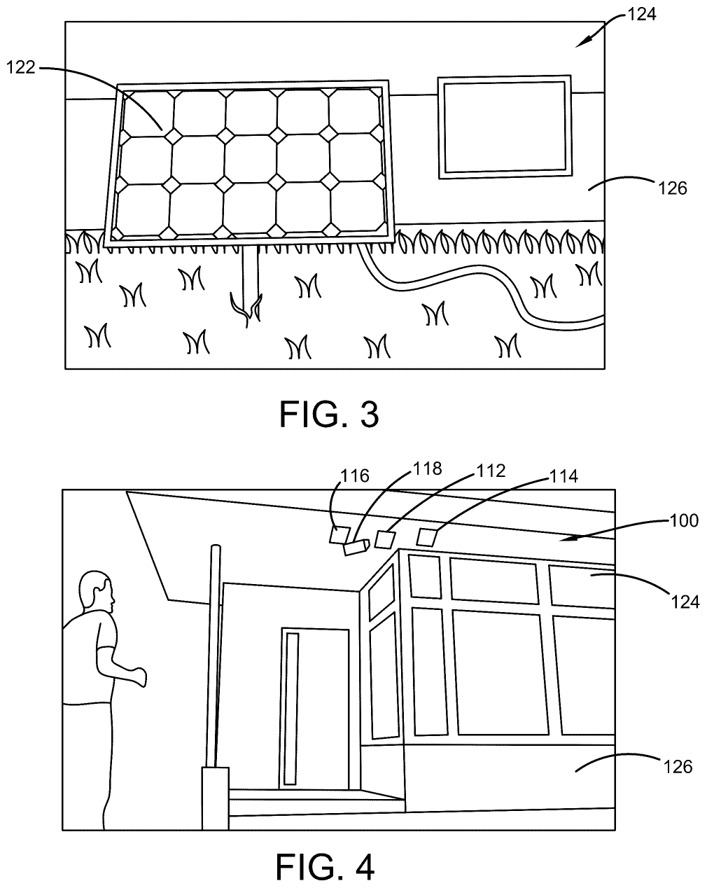

As shown in FIGS. 2-3, each motion detector sensor 112 is mounted to the house 124, gardens, apartment or other premises or structure being monitored, hereinafter referred to as a house 124 for simplicity sake, or on a structure around the house 124 which could be dedicated to the mounting of the motion detector sensor 112. For example, a motion detector sensor 124 could be mounted to the exterior wall 126 of the house 124, to a post around the house, to a tree around the house, or to the roof of the house, etc. The premises or structure being monitored may be any type of premises or structure which is typically monitored for security purposes, including but not limited to, a warehouse, a boatyard, a business, a boat, or a land vehicle such as one with a locating system, etc.

Each motion detector 112 is mounted such that its field of view, i.e., the field in which it detects motion, is around the house 124 in which an intruder could approach the house 124. For example, a motion detector 112 could be arranged to have a field of view in a path leading to the house, a field of view encompassing a length of a fence around the house or a field or a field of view adjacent the house, i.e., adjacent one or more windows of the house, etc. Further, each field of view for a motion detector 112 typically extends over an approximate 180 degree range a sufficient distance from the house 124, the exact distance depending on the type and construction of the motion detector 112 installed in the alarm device 100. Of course, the number, placement and coverage area of the motion detectors 112 will usually vary depending on such factors as the plan outline of the house 124, the location of doors and windows and the surrounding area.

In one embodiment, motion detectors 112 can be standard, off-the-shelf components which provide a signal indicative of the presence of motion above a threshold. In this case, small objects which might be blown aloft by wind, such as leaves, would not trigger the motion detector 112 to provide an output signal. Further, the particular motion detectors 112 selected could be those which only detect animate objects, i.e., humans or animals. In this case, if a fence post in a field of view of a motion detector 112 is being tilted by the wind, it would also not cause the motion detector 112 to provide an output signal. Further, the motion detectors 112 are typically powered by a solar panel 122 or other suitable powering means. The motion detectors 112 are electrically connected to the solar panel 122. The solar panel 122 absorbs sunlight and converts it to usable power for the motion detectors 112. Specifically, the solar panels 122 are capable of receiving energy from the sun. The solar panels 122 are placed such that they face toward the sun. Hence, this facilitates the solar panel 122 to encapsulate sufficient and if possible, an optimal amount of solar energy for the motion detector 112. The solar panels 122 should be kept free of any items that may reduce the available sunlight rays from reaching the solar panels 122.

Furthermore, each camera 118 is mounted to the house 124 or on a structure around the house 124 which could be dedicated to the mounting of the camera 118. For example, a camera 118 could be mounted to the exterior wall of the house 124, to a post around the house, to a tree around the house, or to the roof of the house, etc.

The mounting location of each camera 118 is selected in dependence on its field of view and the field of view of the motion detector or motion detectors 112 with which it is associated. That is, in a preferred embodiment, each camera 118 is triggered to obtain an image only when its associated motion detector 112 detects motion in the field of view of the motion detector 112. Since it is this motion (or the cause thereof) for which an image is sought, one or more of the cameras 118 must be positioned to be able to obtain an image of the portion of the field of view of the motion detector 112 in which motion is detected thereby. In some situations, a single camera 118 can be associated with each motion detector 112 and have substantially overlapping fields of view so that when the motion detector 112 detects motion in its field of the view, the camera 118 is triggered to obtain an image which will necessarily encompass the source or cause of that motion. In other situations, two or more cameras 118 can be associated with each motion detector 112 and be spaced apart from one another. Each camera 118 would have a substantially overlapping field of view with the motion detector 112 so that when the motion detector 112 detects motion in its field of the view, both cameras 118 are triggered to obtain images which will necessarily encompass the source or cause of that motion. The use of multiple cameras 118 for each motion detector 112 will aid in the subsequent image processing routine.

In one embodiment, it is also possible that a single camera 118 has a field of view which encompasses the field of view of multiple motion detectors 112. In this case, when any of a plurality of motion detectors 112 detects motion, that camera 118 will be triggered to obtain an image.

In another embodiment, cameras 118 can also be provided to visualize the house 124, or parts thereof, i.e., a camera 118 can be mounted on a post distant from the door and directed toward the door to obtain an image of the house 124 including the door. The same would also be applicable for images of the windows. Of course, the number, placement and coverage area of the cameras 118 will usually vary depending on such factors as the location of the motion detectors 112, the plan outline of the house, the location of doors and windows and the surrounding area.

In yet another embodiment, cameras 118 can be standard, off-the-shelf components which obtain images in individual frames and as in some conventional cameras, can be equipped with a light which is triggered when the ambient light is less than a threshold. Cameras 118 can also be used which are infrared cameras which obtain infrared images.

In another embodiment, the security cameras 118 are coupled to the motion detectors 112, such that the security cameras 118 do not continually operate and obtain images of the environment around or including the house 124. Rather, the security cameras 118 are only activated to obtain images when motion is detected by the associated one(s) of the motion detectors 112. This conserves electricity or battery power and is thus especially useful when the security cameras 118 are operating on battery power.

As shown in FIG. 4, at least one light 114 is mounted to the house 124 or on a structure around the house which could be dedicated to the mounting of the light 114. For example, a light 114 could be mounted to the exterior wall 126 of the house 124, to a post around the house, to a tree around the house, or to the roof of the house, etc. Of course, the number, placement and coverage area of the lights 114 will usually vary depending on such factors as the location of the motion detectors 112 and cameras 118, the plan outline of the house 124, the location of doors and windows and the surrounding area.

In one embodiment, lights 114 can be standard, off-the-shelf components with any suitable light bulb as is known in the art. Further, the light 114 can be manually activated, on a timer, triggered when the ambient light is less than a threshold, or activated by a motion sensor 112 or camera 118. Thus, in one embodiment, the lights 114 flash when an intruder is detected by the motion sensor 112 or camera 118.

Further, at least one speaker 116 is mounted to the house 124 or on a structure around the house 124 which could be dedicated to the mounting of the speaker 116. For example, a speaker 116 could be mounted to the exterior wall 126 of the house 124, to a post around the house, to a tree around the house, or to the roof of the house, etc. Of course, the number, placement and coverage area of the speakers 116 will usually vary depending on such factors as the location of the motion detectors 112 and cameras 118, the plan outline of the house 124, the location of doors and windows and the surrounding area.

In one embodiment, speakers 116 can be standard, off-the-shelf components as is known in the art. Further, the speakers 116 are typically activated by a motion sensor 112 and/or camera 118 to emit a human voice alarm or expel a sound when an intruder is detected. Specifically, the speaker 116 can announce words and phrases to further deter people from intruding on a person's property. Furthermore, a user can create a bank 128 of human voice recordings to be used as an alarm. Thus, when the motion sensor 112 and/or camera 118 is activated, the speaker 116 will emit a human voice alarm.

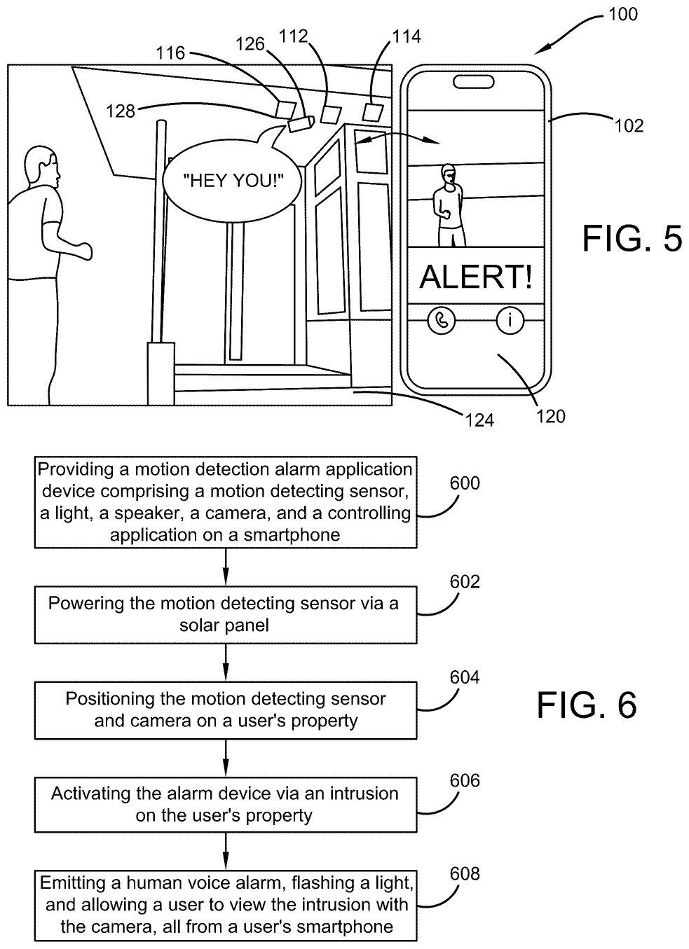

As shown in FIG. 5, the motion detection alarm application device 100 pairs with a user's smartphone 102 via Wi-Fi or Bluetooth, immediately notifying homeowners of an intruder and providing them with a livestream video feed. Specifically, the motion detection alarm application device 100 comprises a software application 120 which is utilized by a user to control the device 100. Thus, the device 100 is designed to be controlled by and/or provide data to a handheld telecommunications unit, such as a smartphone 102 through the software application 120. Users can use the software application 120 to view a livestream video feed of the security cameras 118, send notifications, and/or receive alerts, etc.

In one embodiment, the motion detection alarm application device 100 utilizes a smartphone 102, a tablet, a laptop or a desktop computer, etc., or any other suitable electronic device that has the required operating and memory parameters to support the software application 120 of the present invention.

In another embodiment, the motion detection alarm application device 100 utilizes a mobile computing device 102 (i.e., smart phone, computer, tablet, etc.) comprising a software application 120 which is an alarm app designed to monitor and alert a user to possible intruders detected by the security camera 118 and motion sensor 112. The mobile or software application 120 provides a secure website and/or smart phone app access by users for monitoring and sending any necessary alerts. In addition to these elements, the device 100 of the present invention may also include: a web server and Cloud database of previous images detected by the security camera 118 and data connectable to the mobile smartphone 102 or portable tablet or computer device.

Furthermore, in one embodiment of the invention, the user's data and data management software are maintained on a Microsoft Cloud server in a typical fashion, or other cloud server, such as the Adobe, Apple or Amazon cloud server, etc. A secure cloud server is used for the protection and security of the user's data, and other needed information data stored on the cloud server for the other services. Thus, the user's data is sent to the cloud server and collected. Conveniently, the data is stored and managed with a data management software or program to manage the collected data.

Typically, a cellular wireless data network embedded in the computer, tablet or smartphone 102, etc., transmits data and sends alerts, as needed. Such data and alerts can be processed by a Cloud data management server.

Furthermore, when the motion detection alarm application device 100 is activated (i.e., via the motion detecting sensor 112 and/or camera 118 detecting an intruder), the speaker 116 will emit a human voice alarm, a light 114 will flash, and a notification is sent to a user so that a user can view the intrusion via a live feed with the camera 118, all from the user's smartphone 102 via the software application 120.

In yet another embodiment, the motion detection alarm application device 100 comprises a plurality of indicia 500. The software application 120 of the device 100 may include advertising, a trademark, or other letters, designs, or characters, printed, painted, stamped, or integrated into the software application 120, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be motion detection, alarm, or brand related.

FIG. 6 illustrates a flowchart of the method of protecting a user's property via a software application paired with a security camera. The method includes the steps of at 600, providing a motion detection alarm application device comprising a motion detecting sensor, a light, a speaker, a camera, and a controlling application on a smartphone. The method also comprises at 602, powering the motion detecting sensor via a solar panel. Further, the method comprises at 604, positioning the motion detecting sensor and camera on a user's property. The method also comprises at 606, activating the alarm device via an intrusion on the user's property. Finally, the method comprises at 608, emitting a human voice alarm, flashing a light, and allowing a user to view the intrusion with the camera, all from a user's smartphone.

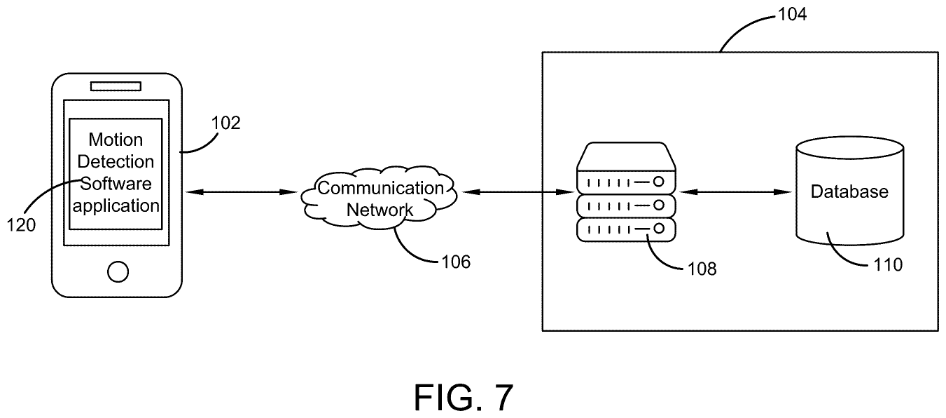

FIG. 7 is a schematic diagram illustrating one embodiment of the motion detection alarm application 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch sensitive device, a tablet, a computing device, a smart-phone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a. NET framework, a personal home page (PHP) framework, or any web-application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with users'account information from the application 100, as well as utility information and predetermined thresholds. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

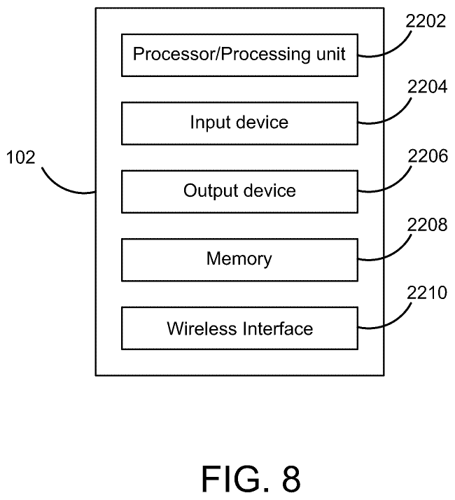

FIG. 8 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “motion detection alarm application device”, “motion detection device”, “alarm application device”, and “device” are interchangeable and refer to the motion detection alarm application device 100 of the present invention.

Notwithstanding the forgoing, the motion detection alarm application device 100 of the present invention can be of any suitable size and configuration as is known in the art without affecting the overall concept of the invention, provided that it accomplishes the above stated objectives. One of ordinary skill in the art will appreciate that the motion detection alarm application device 100 as shown in FIGS. 1-8 is for illustrative purposes only, and that many other sizes and shapes of the motion detection alarm application device 100 are well within the scope of the present disclosure. Although the dimensions of the motion detection alarm application device 100 are important design parameters for user convenience, the motion detection alarm application device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motion detection alarm application device that protects a user's property from intruders, the motion detection alarm application device comprising:
a motion detecting sensor;
a light;
a speaker;
a security camera; and
a mobile application;
wherein the light, the speaker, the security camera, and the motion detecting sensor are positioned around a user's house and yard to detect intruders; and
further wherein the light, the speaker, the security camera, and the motion detecting sensor are in communication with each other, such that when an intruder is detected, the speaker emits a human voice alarm, the light flashes, and a user can view a live feed of the intruder from the security camera, all from a user's smartphone via the mobile application.

2. The motion detection alarm application device of claim 1, wherein the light, the speaker, the security camera, and the motion detecting sensor are all housed together within one structure and mounted around a user's house and yard.

3. The motion detection alarm application device of claim 2, wherein the light, the speaker, the security camera, and the motion detecting sensor are all separate structures and mounted around a user's house and yard.

4. The motion detection alarm application device of claim 3, wherein the motion detecting sensor is powered by at least one solar panel.

5. The motion detection alarm application device of claim 4, wherein the motion detecting sensor is electrically connected to the at least one solar panel.

6. The motion detection alarm application device of claim 5, wherein the at least one solar panel absorbs sunlight and converts it to usable power for the motion detecting sensor.

7. The motion detection alarm application device of claim 6, wherein the security camera can be equipped with a light which is triggered when ambient light is less than a threshold.

8. The motion detection alarm application device of claim 7, wherein the security camera is coupled to the motion detecting sensor, such that the security camera does not continually operate and obtain images but is only activated to obtain images when motion is detected by the motion detecting sensor.

9. The motion detection alarm application device of claim 8, wherein the light can be manually activated, on a timer, triggered when the ambient light is less than a threshold, or activated by a motion detecting sensor or security camera.

10. The motion detection alarm application device of claim 9, wherein the light flashes when an intruder is detected by the motion detecting sensor or security camera.

11. The motion detection alarm application device of claim 10, wherein the speaker is activated by the motion detecting sensor or the security camera to emit a human voice alarm or expel a sound when an intruder is detected.

12. The motion detection alarm application device of claim 11, wherein a user can create a bank of human voice recordings to be used as an alarm, such that when the speaker is activated, it will announce words and phrases.

13. The motion detection alarm application device of claim 12, wherein the motion detection alarm application device pairs with a user's smartphone via Wi-Fi or Bluetooth, immediately notifying homeowners of an intruder and providing them with a livestream video feed.

14. The motion detection alarm application device of claim 13, wherein the motion detection alarm application device is in communication with a mobile application on a smartphone.

15. The motion detection alarm application device of claim 14, wherein users can use the mobile application to view a livestream video feed of the security camera, send notifications, or receive alerts.

16. A motion detection alarm application device that protects a user's property from intruders, the motion detection alarm application device comprising:
a motion detecting sensor powered by at least one solar panel;
a light;
a speaker;
a security camera; and
a mobile application;
wherein the light, the speaker, the security camera, and the motion detecting sensor are all housed together within one structure and mounted around a user's house and yard to detect intruders;
wherein the security camera is coupled to the motion detecting sensor, such that the security camera does not continually operate and obtain images but is only activated to obtain images when motion is detected by the motion detecting sensor;
wherein the light, the speaker, the security camera, and the motion detecting sensor are in communication with each other, such that when an intruder is detected, the speaker emits a human voice alarm, the light flashes, and a user can view a live feed of the intruder from the security camera, all from a user's smartphone via the mobile application;
wherein a user can create a bank of human voice recordings to be used as an alarm, such that when the speaker is activated, it will announce words and phrases;
wherein the motion detection alarm application device pairs with a user's smartphone via Wi-Fi or Bluetooth, immediately notifying homeowners of an intruder and providing them with a livestream video feed; and
further wherein a user controls the motion detection alarm application device via the mobile application on the smartphone.

17. The motion detection alarm application device of claim 16 wherein the smartphone is a cellular phone, a tablet, a laptop or a desktop computer.

18. The motion detection alarm application device of claim 16, wherein the mobile application provides a secure website, and may also include a web server and Cloud database for storing data and data management.

19. The motion detection alarm application device of claim 16 further comprising a plurality of indicia.

20. A method of protecting a user's property via a software application paired with a security camera, the method comprising the following steps:
providing a motion detection alarm application device comprising a motion detecting sensor, a light, a speaker, a camera, and a controlling application on a smartphone;
powering the motion detecting sensor via a solar panel;
positioning the motion detecting sensor and camera on a user's property;
activating the alarm device via an intrusion on the user's property; and
emitting a human voice alarm, flashing a light, and allowing a user to view the intrusion with the camera, all from a user's smartphone.
